(19) United States
(12) Patent Application Publication
(10) Pub. No.: US 2022/0105366 A1
(43) Pub. Date: Apr. 7, 2022

(54) MASK STRUCTURE WITH EXTERNALLY CONNECTED FILTERING DEVICE

(71) Applicants: Kai Pao LEE, Hsinchu City (TW); Yuan Ju CHENG, Kaohsiung City (TW)

(72) Inventors: Kai Pao LEE, Hsinchu City (TW); Yuan Ju CHENG, Kaohsiung City (TW); Chih Yuan CHENG, Kaohsiung City (TW); Chien Hsian KAO, New Taipei City (TW)

(73) Assignees: Kai Pao LEE, Hsinchu City (TW); Yuan Ju CHENG, Kaohsiung City (TW)

(21) Appl. No.: 17/488,266

(22) Filed: Sep. 28, 2021

(30) Foreign Application Priority Data
Oct. 6, 2020 (TW) 109134652

(51) Int. Cl. A62B 7/10; A41D 13/11; A62B 7/12; A62B 18/00; A62B 9/02; A62B 18/10; A62B 18/02; A62B 23/02; F04D 25/06; B01D 53/88; B01D 46/00; B01D 53/00

(52) U.S. Cl. CPC A62B 7/10; B01D 2259/804; A62B 7/12; A62B 18/006; A62B 9/02; A62B 18/10; A62B 18/025; A62B 23/02; F04D 25/06; B01D 53/885; B01D 46/0027; B01D 53/007; B01D 2255/802; B01D 2255/20707; B01D 2255/20792; B01D 2255/2094; B01D 2279/40; A41D 13/11

(57) ABSTRACT

A mask structure with an externally connected filtering device includes a mask body, a unidirectional air seat valve, at least one connecting tube and a filtering device. The mask body is made of an air-impermeable material, can be provided with the unidirectional air seal valve thereon and connected with the filtering device through the connecting tube, so that the mask structure can filter and purify ambient air by the filtering device, and deliver the filtered air to the inner side of the mask body through the connecting tube for a user to inhale. The exhaled air by the user can be expelled through the unidirectional air seal valve to the outer side of the mask body.

### CROSS-REFERENCE TO RELATED PATENT APPLICATION

This non-provisional application claims priority to and the benefit of, under 35 U.S.C. § 119(a), Taiwan Patent Application No. 109134652, filed in Taiwan on Oct. 6, 2020. The entire content of the above identified application is incorporated herein by reference.

### FIELD

The present disclosure relates to a mask structure, and more particularly to a mask structure in which filtered and purified air can be delivered to the inner side of a mask body through connection between a connecting tube and a filtering device.

### BACKGROUND

“PM2.5” refers to particulate matter with an aerodynamic diameter of 2.5 μm or less and is therefore also known as fine particles. These fine particles (hereinafter referred to as PM2.5) are produced not only by human behaviors (e.g., the exhaust of motor vehicles, tobacco smoke, and emissions from coal-fired power stations), but also by natural processes such as dust storms and volcanic eruptions. PM2.5 can be generally categorized as primary or secondary. Primary PM2.5 refers to particles that already fit the PM2.5 definition when emitted into the atmosphere, including for example suspended particles of sea salt, carbon particles emitted from motor vehicles, dust flying up from the road surface, and carbon particles of coal. Secondary PM2.5 (also referred to as secondary aerosols) refers to particles formed of even finer emissions by way of a physical reaction (e.g., condensation) or chemical reaction (e.g., photochemical reaction), including for example sulfates, nitrates, ammonium salts, and organic aerosols.

PM2.5 poses a serious threat to human health because the surface of PM2.5 may adsorb a large amount of toxic substances such as dioxin, polycyclic aromatic hydrocarbons, mercury, lead, and benzene, which in turn may pass through the barriers of the human respiratory system and go deep into the lungs along with PM2.5 due to the small particle sizes of PM2.5. Studies conducted by the World Health Organization (WHO) have shown that on a yearly and global basis, about 3% of cardiopulmonary diseases, and about 5% of lung cancer, can be attributed to PM2.5, causing about 3.1 million deaths per year globally. In particular, PM2.5 containing an acidic aerosol such as a sulfate is highly hazardous. According to the United States National Air Pollution Control Administration, most acidic aerosols have particle sizes smaller than 2.5 μm, can be deposited in the lower respiratory tract and the alveoli through respiration, and may directly result in a reduction or impairment of the functions of the lungs and the respiratory tract and thus affect human health. Such acidic aerosols are detrimental to, and may raise the chronic disease morbidity of, those who are hypersensitive, such as the elderly, children, and patients with a respiratory disease.

In view of the above, some people choose to wear a personal protective device (e.g., a mask) to lower the risk of exposure to PM2.5. Furthermore, the recent pandemic of coronavirus disease 2019 (COVID-19) has turned mask wearing into an essential self-protective behavior, and in consequence the demand for masks has increased significantly. However, insufficient production capacity and a lack of raw materials have given rise to the trend, if not a necessity for the time being, of using masks repeatedly. As a solution, the market has been supplied with a variety of ventilation masks. A ventilation mask includes an extraction fan provided on the mask body to facilitate filtration of ambient air. The extraction fan, however, adds to the weight of the ventilation mask such that the force applied to a wearer's ears is also increased, and the discomfort of wearing the mask may hence intensify as the mask is worn for an extended period of time, thus lowering the wearer's willingness to wear the mask. One of the issues to be addressed in the present disclosure is to improve the conventional mask structures so as to provide mask users with better user experience.

### SUMMARY

As a conventional mask structure when in use still suffers from the issues described above, based on years of experience and excelling spirit, after a series of experiments and research, a mask structure with an externally connected filtering device is provided in the present disclosure to afford users better use experience.

One aspect of the present disclosure is directed to a mask structure. The mask structure includes a mask body, a unidirectional air seal valve, a filtering device, and at least one connecting tube. The mask body made of an air-impermeable material. The unidirectional air seal valve is disposed on the mask body and can allow air to flow only from an inner side of the mask body to an outer side of the mask body. The filtering device can filter and purify ambient air when turned on. The at least one connecting tube has a first end connected to the filtering device and a second opposite end connected to the mask body, and can deliver filtered and purified air to the inner side of the mask body for a user to inhale. The exhaled air by the user can be expelled through the unidirectional air seal valve to the outer side of the mask body.

This and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram of a mask structure according to certain embodiments of the present disclosure.

FIG. 2 is an exploded schematic diagram of the mask structure according to certain embodiments of the present disclosure.

FIG. 3 is a schematic diagram of a filtering device according to certain embodiments of the present disclosure.

FIG. 4 is a schematic diagram of a fan according to certain embodiments of the present disclosure.

FIG. 5 is a cross-sectional diagram of a fan guard according to certain embodiments of the present disclosure.

### DETAILED DESCRIPTION

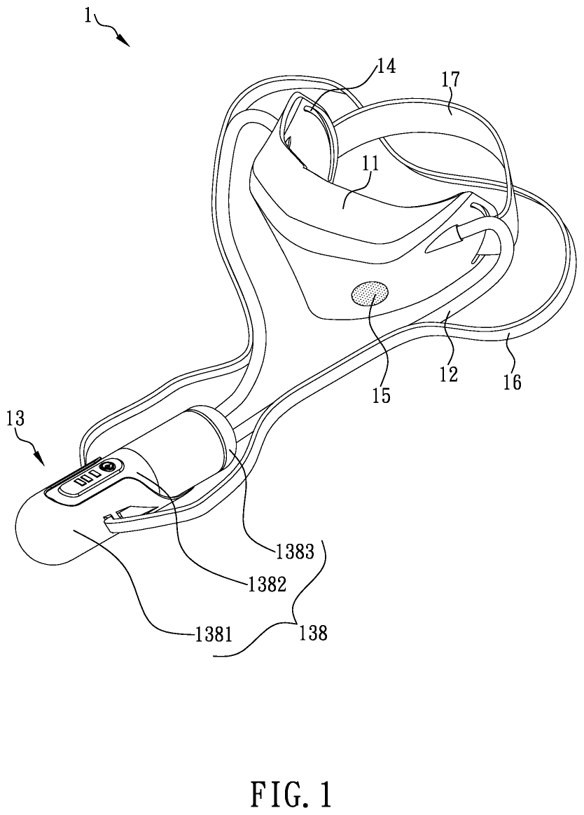

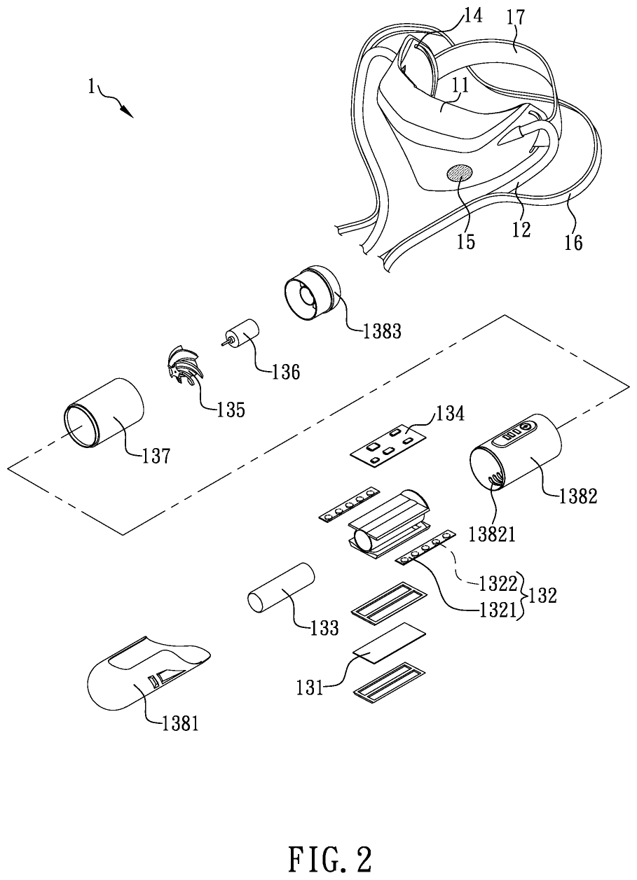

The present disclosure provides a mask structure with an externally connected filtering device. The terms including “first”, “second” and “third” referred in the present disclosure are intended to express different components or items only, and not any particular assembling or arranging sequence thereof when in actual use. Referring to FIG. 1 and FIG. 2, in certain embodiments, the mask structure 1 according to the present disclosure includes a mask body 11, a unidirectional air seal air seal valve 15, at least one connecting tube 12, and a filtering device 13. The mask body 11 is made of an air-impermeable material (e.g., a plastic material) and is provided with the unidirectional air seal valve 15. The unidirectional air seal valve 15 allows air to flow only from the inner side of the mask body 11 to the outer side of the mask body 11, and ambient air is not allowed to flow through the unidirectional air seal valve 15 to the inner side of the mask body 11. The mask body 11 is connected to the filtering device 13 through the connecting tube 12. When the filtering device 13 is in the turned-on state, ambient air enters the filtering device 13 for filtration and purification, and the filtered and purified air is delivered to the inner side of the mask body 11 through the connecting tube 12 in order to be inhaled by the user. The air exhaled by the user is discharged to the outer side of the mask body 11 through the unidirectional air seal valve 15.

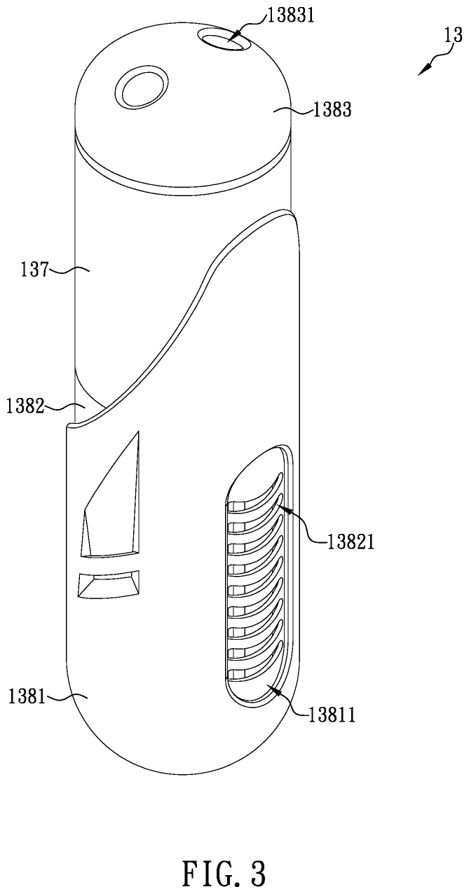

Referring to FIG. 1 to FIG. 3, the filtering device 13 includes a housing 138, a filter plate 131, and a photocatalyst module 132. In certain embodiments, the housing 138 includes a first housing element 1381, a second housing element 1382, and a third housing element 1383. The housing elements 1381, 1382, and 1383 can be assembled to each other by fixing means such as mechanical engagement, adhesive bonding, or other fixing means in order to form a single unit. In certain embodiments, the housing 138 can include a single housing element, two housing elements, or four or more housing elements instead. The first housing element 1381 is provided with at least one first air inlet hole 13811, and the second housing element 1382 is provided with at least one second air inlet hole 13821. The first housing element 1381 can be mounted around the outer surface of the second housing element 1382 and the first air inlet hole 13811 corresponds in position to the second air inlet hole 13821 (see FIG. 3). The filter plate 131 can be located in the second housing element 1382 and correspond in position to the second air inlet hole 13821. When air passes through the filter plate 131, the filter plate 131 adsorbs particles in the air through electrostatic adsorption in order to filter out more than 90% of 5 μm particles (which are approximately the sizes of cells and bacteria). The configuration of the filter plate 131, however, is not limited to that described above. Depending on actual product requirements, the filter plate 131 may be a mesh layer containing activated carbon in order to adsorb volatile organic compounds (VOC) and odorous molecules in the air, and the filter plate 131 may be shaped by cutting by a user and regularly replaced. For example, a user may cut a mask or other plate-shaped materials having a filtering effect and use the material obtained as the filter plate 131.

The photocatalyst module 132 can also be located in the second housing element 1382 and include a photocatalytic material 1321 (e.g., titanium dioxide, zinc oxide, tin(IV) oxide, cadmium sulfide, etc.) and an optical energy device 1322 (e.g., a UVC LED). The optical energy device 1322 is configured to cause an oxidation or reduction reaction of the photocatalytic material 1321. More specifically, when the photocatalytic material 1321 is irradiated with the optical energy generated by the optical energy device 1322, electrons (e⁻) in the photocatalytic material 1321 jump from the valence band to the conduction band, leaving positively charged electron holes (h⁺) behind. The electrons will combine with oxygen molecules to form highly reductive superoxide ions (O₂⁻), and the electron holes will react with the moisture on the surface of the photocatalytic material 1321 to produce highly oxidative hydroxyl radicals (−OH). The superoxide ions and hydroxyl radicals are highly active and can participate in an oxidation or reduction reaction with the surface of an object to decompose organic matter, thereby producing a bactericidal or bacteriostatic effect. The working principle of the photocatalyst module 132, however, is not limited to that described above. In certain embodiments, the optical energy device 1322 is configured to generate wavelengths ranging from 100 nm to 280 nm, which wavelengths are sufficient to destroy the molecular structure of the deoxyribonucleic acid (DNA) or ribonucleic acid (RNA) of a microbe. Generally, the UV spectrum approximately from 200 nm to 300 nm (i.e., the range of wavelengths absorbable by DNA) is critical to air disinfection. The optical energy device 1322, therefore, can produce a bactericidal or bacteriostatic effect by killing bacteria or preventing bacterial reproduction. When ambient air flows into the housing 138 through the first air inlet hole 13811 and the second air inlet hole 13821, the filter plate 131. can filter out a large amount of particulate matter and microbes, and the remaining particulate matter and microbes will be decomposed and destroyed by the photocatalyst module 132 to achieve the intended effect of filtration and purification. However, in certain embodiments, the photocatalyst module 132 may be omitted according to the practical filtering needs of the mask structure 1.

Referring to FIG. 2, the filtering device 13 in certain embodiments further includes an electric power unit 133 (e.g., a battery), a control unit 134 (e.g., an IC control panel), a fan 135, and a motor 136. The electric power unit 133 and the control unit 134 can be located in the second housing element 1382. The electric power unit 133 is configured to provide certain components of the filtering device 13 (e.g., the optical energy device 1322, the fan 135, and the motor 136) with the electric power required for their operation. The control unit 134 is configured to control the activation and deactivation of certain components of the filtering device 13 (e.g., the optical energy device 1322, the fan 135, and the motor 136). When activated, the control unit 134 can instruct the electric power unit 133 to supply electricity to the optical energy device 1322, the fan 135, and the motor 136. Once the control unit 134 is deactivated, the electric power unit 133 stops supplying electricity to the optical energy device 1322, the fan 135, and the motor 136. The function of the control unit 134, however, is not limited to that described above. The control unit 134 may be configured to also control the respective conditions of the optical energy device 1322, the fan 135, and the motor 136. For example, the control unit 134 may be able to adjust the intensity of the optical energy generated by the optical energy device 1322, in order for the optical energy device 1322 to output different optical power. The higher the optical power, the farther the optical energy can reach. The control unit 134 may be able to adjust the wind speed of the fan 135, and the higher the wind speed, the greater the airflow. In addition, the control unit 134 may be able to adjust the driving power and/or other parameters of the motor 136 and/or other components.

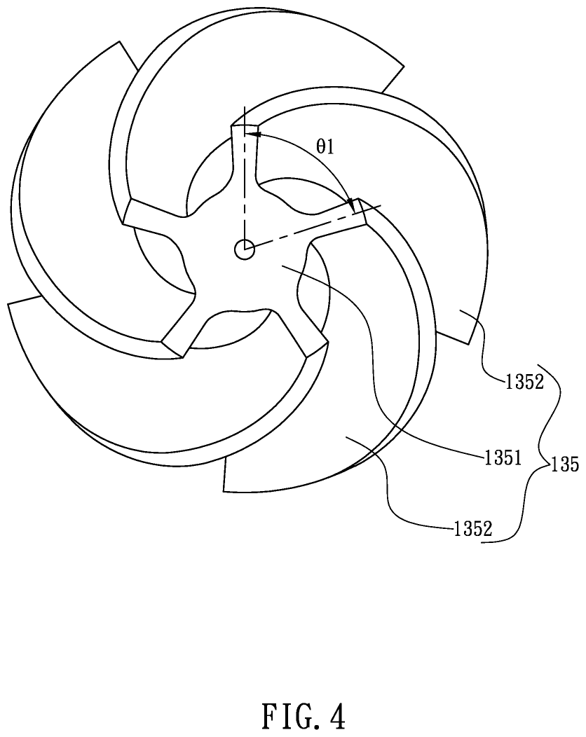

Referring to FIG. 4, the fan 135 in certain embodiments includes a central shaft 1351 and a plurality of vanes 1352. The vanes 1352 are provided on, and around the circumference of, the central shaft 1351, with a space between each two adjacent vanes 1352. Each vane 1352 extends curvedly from the end corresponding to the central shaft 1351 toward the opposite end. The fan 135 may have 4 to 10 vanes 1352. Each two adjacent vanes 1352 of the fan 135 form an included angle θ1, and the included angle θ1 may range from 30 degrees to 80 degrees. The included angle θ1 between each two adjacent vanes 1352 is designed to produce a forward airflow (i.e., toward an air outlet hole 13831) in compliance with the principles of fluid mechanics so that the airflow is more concentrated and stronger. When the vanes 1352 are rotated, the air around the vanes 1352 is driven by friction with the vanes 1352.

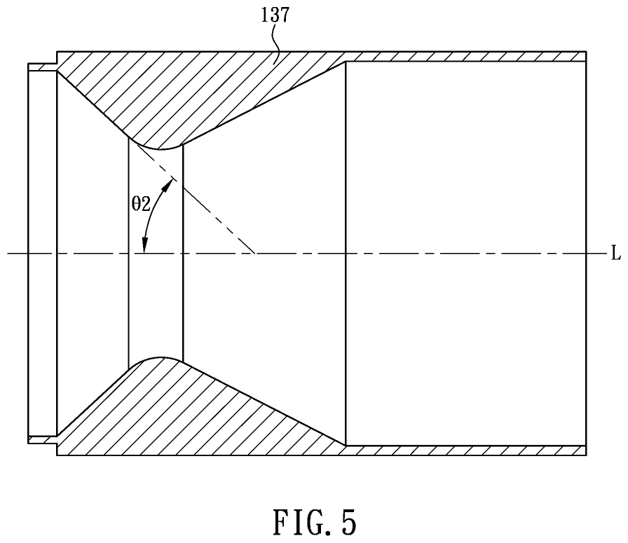

Referring to FIG. 2, FIG. 3, and FIG. 5, the fan 135 can be fixedly disposed in a fan guard 137. The fan guard 137 has one end configured to be connected to the second housing element 1382 and the other end configured to be connected to the third housing element 1383. The longitudinal cross-section of the fan guard 137 is so designed that when traced from one end of the fan guard 137, the inner wall of the fan guard 137 converges toward, and thus forms an included angle θ2 with, the central axis L of the fan guard 137 (see FIG. 5), and then diverges with respect to the central axis L, wherein the included angle θ2 may range from 30 degrees to 50 degrees. As a result, the longitudinal cross-section of the interior space of the fan guard 137 changes longitudinally from a relatively great width to a relatively small width and then to another relatively great width. When air is flowing through the fan guard 137, the speed of the air varies with the transverse cross-sectional area of the interior space of the fan guard 137. More specifically, the highest speed, and hence the lowest static pressure, take place in the narrowest part of the interior space of the fan guard 137, and the resulting pressure difference produces an inward suction force that helps enhance the air blowing ability of the fan 135, allowing the filtered and purified air to be delivered through the connecting tube 12 to the inner side of the mask body 11 in a large volume to satisfy the user's inhalation needs.

Referring to FIG. 2 and FIG. 4, when the number of the vanes 1352 of the fan 135 is increased, the area of each single vane 1352 is reduced, meaning the area with which each vane 1352 can react with air is reduced, which in turn reduces the vibrations of each vane 1352 and consequently the resulting noise, the sound of wind shear, and the wind pressure of the outblowing air, thereby enhancing the comfort of use. Moreover, the motor 136 in certain embodiments can convert the electric power provided by the electric power unit 133 into mechanical energy and use this mechanical energy to generate the kinetic energy required for driving the fan 135, allowing the mask structure 1 to filter ambient air with the filtering device 13 and, thanks to the motor 136-driven fan 135, deliver the filtered air through the connecting tube 12 to the inner side of the mask body 11.

Referring to FIG. 2 and FIG. 3, the third housing element 1383 in certain embodiments is provided with at least one air outlet hole 13831, and the air outlet hole 13831 can be connected to one end of the connecting tube 12 while the other end of the connecting tube 12 can be connected to the mask body 11. The connecting tube 12 has an inner diameter of 4 mm to 13 mm to allow passage of a relatively large amount of air and thereby satisfy the inhalation needs of an average individual. Accordingly, ambient air can enter the housing 138 through the first air inlet hole 13811 and the second air inlet hole 13821, then pass through the filter plate 131 to have a large amount of particulate matter and microbes removed, and then pass through the photocatalyst module 132 to decompose the organic matter in the air. The intended filtering and purifying effect, including that being either bactericidal or bacteriostatic, is thus achieved. After that, the filtered and purified air is blown toward the air outlet hole 13831 by the fan 135, whose vanes 1352 are driven to rotate by the motor 136, in order to be delivered through the connecting tube 12 to the inner side of the mask body 11. One who is wearing the mask structure 1, therefore, can inhale the filtered and purified air on the inner side of the mask body 11, and the air breathed out will be discharged through the unidirectional air seal valve 15 to the outer side of the mask body 11. It is worth mentioning that the filtering device 13 is connected to the mask body 11 via the connecting tube 12 rather than provided directly on the mask body 11 and therefore will not burden the wearer by adding to the weight of the mask body 11.

Referring to FIG. 1, the left and right sides of the mask body 11 in certain embodiments are each provided with a through hole 14, and the two ends of a securing strap 17 can be passed through the through holes 14 respectively, allowing a user to wrap the securing strap 17 firmly around the rear of his or her head so that the mask structure 1 can be conveniently put on and securely worn. As an alternative, the mask structure 1 can be put on by sleeving the left and right through holes 14 of the mask body 11 directly onto the user's left and right ears respectively. Or, depending on product requirements, each of the left and right sides of the mask body 11 may be provided with an ear strap to be wrapped around a user's left or right ear so that the inner surface of the mask body 11 is close to the user's face and covers the user's cheeks and chin. The mask structure 1 can be provided with a lanyard 16. The lanyard 16 can be fixedly connected to the first housing element 1381 and can be worn around a user's neck. The lanyard 16, however, is not necessarily so designed, and as long as a lanyard can be fixedly connected to the housing 138 and allows the mask structure 1 to be securely worn on a user's body, it falls in the definition of the lanyard 16 according to the present disclosure.

In certain embodiments, certain portions of the lanyard 16 can be coupled to the corresponding portions of the connecting tube 12 respectively (see FIG. 1). More specifically, the inner surfaces of those portions of the lanyard 16 can be respectively coupled to the outer surfaces of certain portions of the connecting tube 12 (for example, the portions adjacent to the end of the connecting tube 12 that is connected to the air outlet hole 13831) to prevent the connecting tube 12 from being separated from the filtering device 13 by an external pulling force and to enhance the entire mask structure 1 esthetically. The lanyard 16, however, is not necessarily coupled to the connecting tube 12. The lanyard 16 may be separate from the connecting tube 12, and as tong as the connecting tube 12 can deliver air and the lanyard 16 can be worn around a user's neck and/or body, any such configuration of the connecting tube 12 and the lanyard 16 falls in the scope of the present disclosure.

It is noted that the filtering device 12 is not limited to being connected to the mask body 11. In certain embodiments, the filtering device 12 may be separated from the mask body and used as an air circulation device independently and in daily life, and as long as a filtering device has the structure as described above, it falls in the scope of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A mask structure, comprising:
a mask body made of an air-impermeable material;
a unidirectional air seal valve disposed on the mask body and configured to allow air to flow only from an inner side of the mask body to an outer side of the mask body;
a filtering device configured to filter and purify ambient air when turned on; and
at least one connecting tube having a first end connected to the filtering device and a second opposite end connected to the mask body and configured to deliver filtered and purified air to the inner side of the mask body.

2. The mask structure according to claim 1, the filtering device comprising:
a housing formed with at least one air inlet hole for allowing the ambient to pass through the housing therethrough and at least one air outlet hole connected to the first end of the filtering device;
a filter plate disposed inside of the housing, corresponding in position to the air inlet hole, and configured to adsorbs particles in the ambient air through electrostatic adsorption when the ambient air passes through the filter plate;
an electric power unit disposed in the housing and configured to provide electric power to at least one component of the filtering device;
a control unit disposed in the housing and configured to control activation and deactivation of the component of the filtering device;
a fan disposed in the housing and configured to deliver the ambient air passed through the filtering plate to the air outlet hole; and
a motor disposed in the housing and configured to drive the fan.

3. The mask structure according to claim 2, wherein the filtering device further comprises a photocatalyst module disposed in the housing and comprising a photocatalytic material and an optical energy device configured to cause an oxidation or reduction reaction of the photocatalytic material and purify the ambient air passed through the filtering plate.

4. The mask structure according to claim 2, the fan comprising:
a central shaft; and
four to ten vanes provided on, and around the circumference of, the central shaft with a space between each two adjacent vanes, wherein each of the vanes extends curvedly from one end thereof that corresponds to the central shaft toward another opposite end thereof.

5. The mask structure according to claim 4, wherein each two adjacent ones of the vanes form an included angle ranging from 30 degrees to 80 degrees.

6. The mask structure according to claim 2, wherein the fan is fixedly provided in a fan guard assembled to the housing, and an inner wall of the fan guard converges toward and forms an included angle with a central axis of the fan guard that ranges from 30 degrees to 50 degrees.

7. The mask structure according to claim 1, wherein the connecting tube has an inner diameter of 4 mm to 13 mm.

8. The mask structure according to claim 3, wherein the photocatalytic material includes at least one of titanium dioxide, zinc oxide, tin(IV) oxide and cadmium sulfide.

9. The mask structure according to claim 3, wherein the optical energy device 1322 is configured to generate wavelengths ranging from 100 nm to 280 nm.

10. The mask structure according to claim 1, further comprising a lanyard configured to be connected with the housing.
